(19) United States
(12) Patent Application Publication
(10) Pub. No.: US 2014/0168598 A1
(43) Pub. Date: Jun. 19, 2014

(54) Eyewear Attachment Device

(71) Applicant: Elizabeth Spitzer, Gatesville, TX (US)

(72) Inventor: Elizabeth Spitzer, Gatesville, TX (US)

(21) Appl. No.: 14/133,741

(22) Filed: Dec. 19, 2013

Related U.S. Application Data
(60) Provisional application No. 61/739,497, filed on Dec. 19, 2012.

(51) Int. Cl. G02C 11/08; G02C 7/16

(52) U.S. Cl. CPC G02C 11/08; G02C 7/16
USPC 351/62

(57) ABSTRACT

A sweat wicking and glare reducing eyeglass attachment is provided that is adapted to secure to the upper surfaces of a pair of eyeglasses or pair of sunglasses. The attachment comprises a U-shaped frame having a frontal portion and a pair of side portions, wherein the cross section of the frame is J-shaped and comprised of an upstanding portion and an upper overhang portion. The overhang portion secures via clips over the top bar, bridge, and upper portions of both eyeglass lenses, while the side portions of the frame secure to the temples of the eyeglass. The frame further comprises a sweat wicking material layer coextensively disposed thereon that is adapted to draw sweat from the user's skin through capillary action and dry swiftly thereafter. Overall, the device acts as a partial visor along the upper portion of eyeglass and a means of absorbing brow sweat from the user.

### CROSS REFERENCE TO RELATED APPLICATION

This application claims the benefit of U.S. Provisional Application No. 61/739,497 filed on Dec. 19, 2012, entitled “Eyewear Sweatbrow.” The above identified patent application is herein incorporated by reference in its entirety to provide continuity of disclosure.

### BACKGROUND OF THE INVENTION

1. Field of the Invention

The present invention relates to eyewear connection devices and particularly to devices for preventing unwanted fluid, sunlight, and other particles from entering the user's eyes and field of vision. The device comprises a tube-shaped member having a two layer design that attaches to the upper edge of most any style eyewear. The present invention will be appreciated by those who engage in athletic or active work activity while wearing eyewear.

Various types of eyewear exist in the art for the purposes of improving vision of the user, for protecting the user's eyes during certain activities, and further for providing a fashionable accessory wearable over the eyes of a user. Most common eyewear includes a pair of eye lenses disposed over the user's eyes and separated by a bridge, wherein the lenses are supported by nose pads against the user's nose, and temple members that extend from the outer extents of the lenses and secure the same around the ears of the wearer. This configuration is well understood in the art. The present invention is directed to an eyewear accessory that is adapted to address a well-known concern in the art of eyewear: perspiration and debris wicking from the user's forehead and preventing the same from entering the user's eyes during an activity.

It is common to develop forehead sweat while wearing eyewear, particularly for those engaging in performance sports or exercise, or those that are employed in labor or similar non-sedentary occupations in high pressure or higher temperature environments. Typically, most eyewear does not provide adequate protection from this type of unwanted matter entering the ocular regions. Perspiration, rain, water, dirt, sunlight, and other particles that enter the ocular region can become a distraction, become uncomfortable, momentarily blur, or worse, momentarily blind the wearer. This can become a minor to major inconvenience with certain sport activities, but could also be very dangerous for people that are wearing typical eyewear while working with heavy machinery, dangerous equipment (e.g. welding equipment, etc.), or other activities that require extreme focus and care of an operator or player.

In order to prevent the above from occurring, the user must attend to his or her eyewear in an appropriate manner to clear the perspiration or debris that has found its way into the ocular region behind the user's eyewear. The user must stop what he or she is doing, remove the article of eyewear, wipe the foreign particles or fluid away from their face and from the eyewear, replace the eyewear, and then go back to performing the previous activity. This process is not only inconvenient in a sports setting, it is unproductive for the workplace.

The present invention provides an eyeglass attachment device that is adapted to secure to the upper portions of a pair of eyeglasses or sunglasses and provide two primary functions: (1) adding a sun visor or glare shield to the eyewear along the upper portion thereof, and (2) providing a means to absorb sweat from the user's brow and preventing the same from entering the ocular regions of the wearer while the eyewear is donned. The device comprises a frame that secures to the bridge, lens upper portions, and the temples of the eyewear using a plurality of clips and an overhang portion disposed along the frame upper. The frame supports a moisture wicking and rapid drying material that can readily absorb sweat and return to a dry state shortly thereafter. Overall, the device provides a simple, lightweight, and convenient eyewear attachment device for preventing foreign matter from entering the eyes and for partially blocking overhead sunlight.

2. Description of the Prior Art

Devices have been disclosed in the prior art that relate to eyewear attachments. These include devices that have been patented and published in patent application publications. The following is a list of devices deemed most relevant to the present disclosure, which are herein described for the purposes of highlighting and differentiating the unique aspects of the present invention, and further highlighting the drawbacks existing in the prior art.

One such device in the prior art is U.S. Pat. No. 6,789,272 to Thorson, which describes an eyeglass perspiration guard that attaches to eyeglass arms through the use of “O” rings. The perspiration guard has a flexible layer and a plastic layer. The flexible layer is made of absorbent material to wick fluid flowing down the wearer's forehead. The plastic layer is rigid to provide adequate structure in order for the guard to “mold” around the user's forehead. While the device provides partial protection from liquid and other debris from entering the eyes and partial attachment to the eyeglasses, it does not provide the wearer with complete protection and absorption of foreign matter throughout the entire forehead to temple region. In addition, if the absorption material becomes oversaturated, liquid may enter the eyes since there is no drainage functionality built into the design.

U.S. Pat. No. 4,712,254 to Daigle describes another device that is a combination headband and eyeglass device. The device functions as a typical headband but has a specially designed pocket where eyeglasses are slidably protracted therefrom. If the user desires to wear a headband without eyeglasses they can simply detract the eyeglasses into the special pocket. The device is secured to the wearer's head with typical hook and loop fastening elements. While this device provides the user with an eye protection device, it is not readily adaptable to other forms and styles of eyewear, while many other users do not fond of sweatbands as particularly fashionable.

U.S. Pat. No. 4,616,367 to Jean, Jr. et al. describes a headband with detachable and adjustable lenses. The device functions as a typical headband but has specially designed lenses that can flip-down when required and adjusted laterally and angularly for each wearer. The device is also secured to the wearer's head with typical hook and loop fastening elements. While this device provides the user with an eye protection device, it is not readily adaptable to other forms and styles of eyewear and many users do not find sweatbands particularly fashionable.

U.S. Pat. No. 7,434,929 to Jackson describes a liner or pair of liners that are attached to the top frame of eye glasses. The liner or liners are attached to the frame by a lip, tab, and other means that are adapted to fit over the top of the frame. The liner is made of a single piece of material that is flexible and water resistant such as rubber, plastic, or foam. Finally, the liner or liners have one or more grooves located in the upper portion to collect and redirect sweat away from the eyes. While the liners provide an attachable eye protection device, the Jackson device fails to contemplate the frame and wicking material provided by the present invention. The present invention utilizes a series of clips extending from a U-shaped frame, wherein the frame includes a J-shaped cross-section to secure to the upper portions of an article of eyewear. The frame of the present invention extends along a substantial majority of the eyewear upper surface, including the upper surfaces of the eyewear bridge, the lenses, and the temples extending rearward from the lenses.

None of the prior art provide the benefits inherent in the present invention nor do they suggest the present invention. The prior art consists of overly complex and expensive designs or proprietary systems that are not typically available to most users. Therefore, there is a need for a novel and useful eyewear attachment device that quickly and easily attaches to most available eyewear and provides a sweat wicking capability and a sun glare reducing capacity.

It is submitted that the present invention substantially diverges in design elements from the prior art, and consequently it is clear that there is a need in the art for an improvement to existing eyewear attachment devices. In this regard the instant invention substantially fulfills these needs.

### SUMMARY OF THE INVENTION

In view of the foregoing disadvantages inherent in the known types of eyewear attachment devices now present in the prior art, the present invention provides a new foreign debris, sweat, and glare blocking eyewear attachment that can be utilized for providing convenience for the eyewear user during normal activity, during outdoor activity in which sunlight is bothersome, and particularly during strenuous activity in which brow sweat can interfere with vision.

It is therefore an object of the present invention to provide a new and improved eyewear attachment device that has all of the advantages of the prior art and none of the disadvantages.

It is another object of the present invention to provide an eyewear attachment device that is adapted to secure over the upper surfaces of an article of eyewear and be retained thereto while the eyewear is in use.

Another object of the present invention is to provide an eyewear attachment device that is adapted to secure to various types of eyewear, including sunglasses, reading glasses, and the like.

Yet another object of the present invention is to provide an eyewear attachment device that includes a frame secured along a substantial majority of the eyewear upper surface, wherein the frame supports a moisture wicking or moisture absorbing material thereon to absorb perspiration from the wearer's brow, preventing the same from entering into the wearer's ocular region.

Another object of the present invention is to provide an eyewear attachment device that is adapted to block both perspiration, non-wearer developed moistures (water, rain, etc.), and dirt that may otherwise enter the ocular regions of the wearer while wearing eyewear and interfere with normal vision.

Another object of the present invention is to provide an eyewear attachment device that comprises a unitary plastic frame made to fit specific style eyewear or a general design, wherein the frame utilizes clips to secure to the eyewear.

Another object of the present invention is to provide an eyewear attachment device that supports a moisture absorbing and moisture wicking material along the interior portions of the frame, wherein moisture is absorbed from the wearer's skin and the material rapidly returns to a dry state thereafter.

A final object of the present invention is to provide an eyewear attachment device that may be readily fabricated from materials that permit relative economy and are commensurate with durability, wherein contemplated uses include normal eyewear use to more rigorous, athletic, or occupational uses.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an exemplary embodiment of the eyewear attachment device of the present invention.

FIG. 2 shows a perspective view of the eyewear attachment device in use and secured to the upper surfaces of an article of eyewear.

FIG. 3 shows an overhead view of the eyewear attachment device secured to the upper surfaces of an article of eyewear.

FIG. 4 shows a cross section view of the eyewear attachment device frame, attachment clip, and moisture wicking material disposed on the frame.

### DETAILED DESCRIPTION OF THE INVENTION

Reference is made herein to the attached drawings. Like reference numerals are used throughout the drawings to depict like or similar elements of the eyewear attachment device. For the purposes of presenting a brief and clear description of the present invention, the preferred embodiment will be discussed as used for preventing moisture and dirt from entering the ocular areas of the wearer, while also partially shielding the wearer's eyes from glare and overhead sunlight. The figures are intended for representative purposes only and should not be considered to be limiting in any respect.

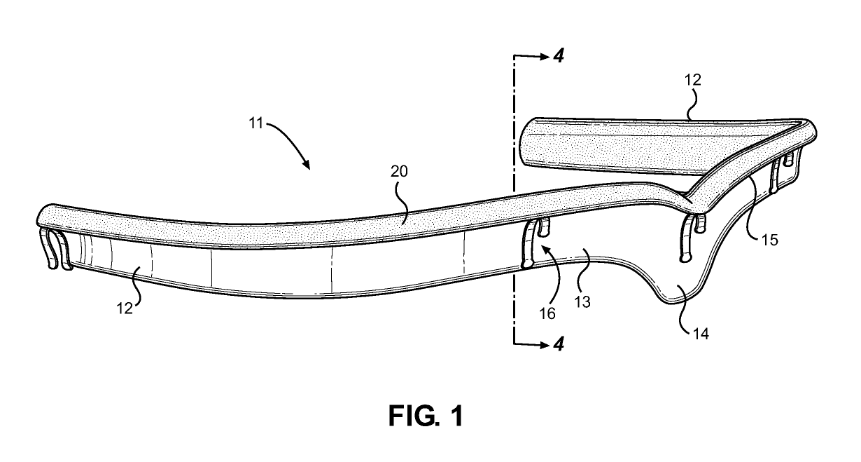

Referring now to FIG. 1, there is shown a perspective view of the eyewear attachment device of the present invention. The device comprises a substantially U-shaped frame 11 that is adapted to rest against and secure to the upper surfaces of an article of eyewear. Contemplated eyewear include normal reading and prescription glasses, sports and athletic eyewear, as well as more occupational or shop eyewear. The frame 11 is preferably a plastic or similar lightweight material that will not unduly burden or substantially increase the weight of the eyewear while donned.

The frame 11 comprises a frontal portion 13 and a pair of side portions 12 that form a substantial U-shape. The side portions 12 extend rearward from the frontal portion 13 along substantially the same plane and are adapted to secure over the temples of the eyewear article. The frontal portion 13 comprises a bridge area 14 that is centrally located thereon. The bridge area 14 secures over the bridge portion of the eyewear to center the frame 11 and properly locate the same relative to the structure of the eyewear.

To secure the frame, a plurality of U-shaped clips 16 are disposed around the frame periphery, including along the side portions 12 and frontal portion 13. The clips 16 are elastic members biased toward the frame 11 such to pinch and secure the article of eyewear to the frame at different locations therealong. A preferred positioning of the clips 16 is shown in the figures, wherein clips 16 are provided along both the side portions 12 and the front portion 13 of the frame 11. The side portion clips secure the temples of the eyewear, while clips along the frontal portion 14 secure over the bridge area 14 and over the lens locations of the eyewear. The exact positioning of the clips 16 and the number deployed along the frame 11 may change, depending on the exact design of the device and the type of eyewear the frame 11 may be specifically designed for.

The frame 11 comprises a cross section that is J-shaped, wherein the frame includes an upstanding portion and an overhang portion 15 extending outward therefrom along the frame upper. The overhang portion 15 is adapted to extend over the upper surfaces of the eyewear, while the upstanding portions of the frame are adapted to secure along the upper, interior surface thereof. The upstanding portion includes a frontside and a backside surface, wherein the frontside surface is the interior portion of the J-shaped cross section and the backside surface is the outside portion of the J-shaped cross section. The frontside surface supports the clips 16, while the backside surface comprises a moisture wicking material 20 coextensively disposed thereon.

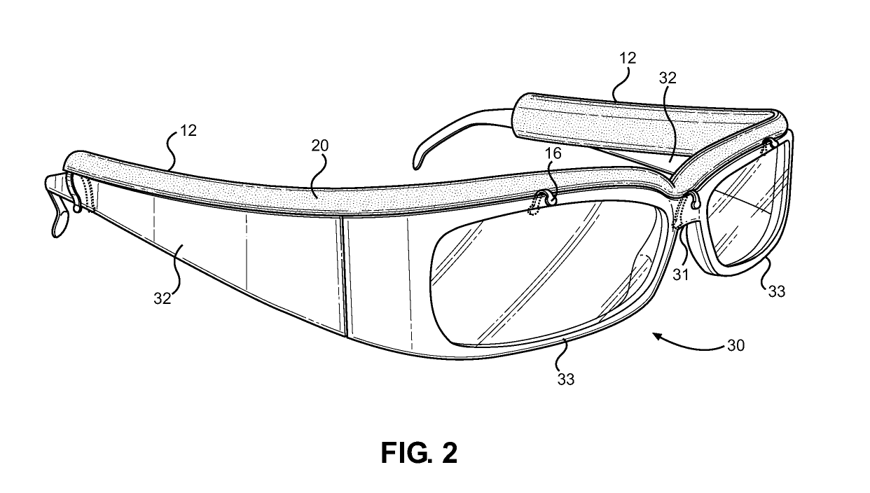

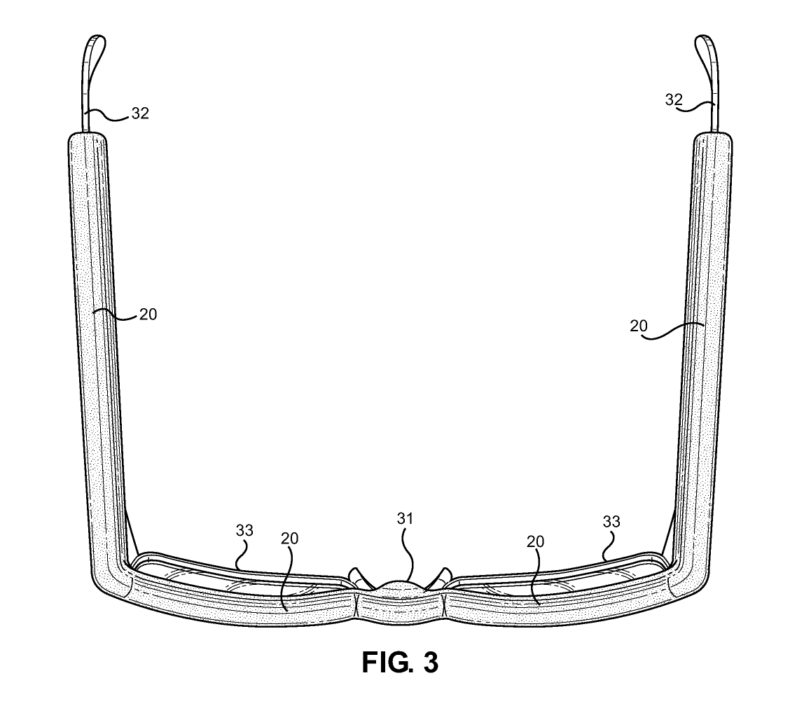

Referring now to FIGS. 1, 2, and 3, the eyewear attachment device is shown by itself and attached to eyewear 30. The frame side portions secure over the temples 32 of the eyewear 30, while the frontal portion of the frame secures over the bridge 31 and upper surfaces of the eyewear lens 33. The frame secures to the eyewear 30 such that the moisture wicking material 20 thereof is positioned inwardly from the upper portions of the eyewear such that the material 20 contacts the user's face while the eyewear 30 is donned.

This positioning of the material against the user's skin creates a physical barrier for moisture and debris above the user's eyes, wherein the moisture and debris may otherwise be free to flow into the ocular regions of the wearer and create vision problems. Commonly available eyewear, particularly those articles for reading and normal use, exhibit a gap between the upper portions of the eyewear and the brow and temple regions of the user. This gap allows moisture developed through perspiration, from rain, or from water otherwise contacting the user's brow, to flow readily into the user's eyes. Further still, this opening allows for near-direct sunlight to enter the user's eyes. The present invention contemplates a dual-function attachment that functions particularly well for blocking moisture and debris, while also functioning as a visor or glare shield along the upper portion of the eyewear.

The attachment clips 16 of the frame include elastically biased members, preferably comprising an elastic, plastic material that extends from the overhang portion of the frame and secures around the upper portions of the eyewear to secure the same within the interior of the frame. The clips 16 along the side portions 12 of the frame (side portion attachment clips) may be substantially U-shaped members adapted to encircle the temples of the eyewear. The clips 16 above the bridge 31 and lens areas 33 of the eyewear (frontal portion attachment clips) are adapted to be shorter than those of the side portions, wherein the clips do not overlap any of the lenses or create any visual interference that may distract or otherwise obstruct the user's normal vision therethrough. These frontal portion attachment clips are substantially J-shaped, wherein the clip does not extend downward to the extent that the side portion attachment clips extend.

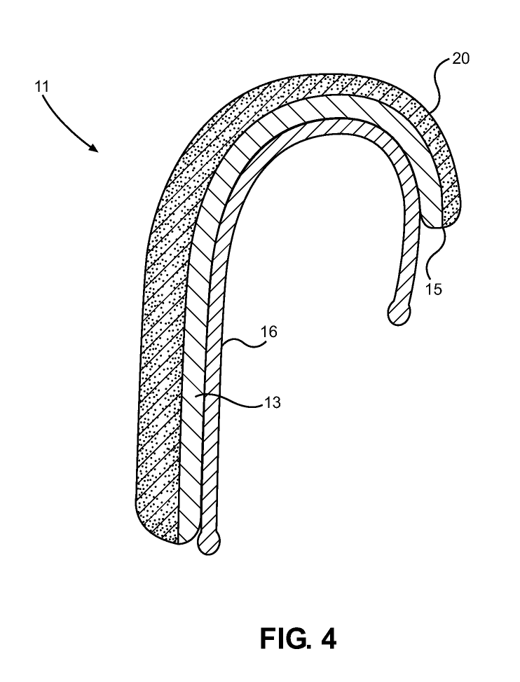

Referring now to FIG. 4, there is shown a cross section view of the eyewear attachment device of the present invention. From this view, the layers of the device are readily visible, The cut line is taken through the frontal portion 13 of the frame 11, the moisture absorbing material 20 backing thereof, and also through the attachment clip 16 of the device. As shown, the frame is a largely (inverted) J-shaped structure. The frame 11 includes an upstanding portion having a lower edge and an upper portion that includes an overhang portion 15 extending outward therefrom (forming the inverted J-shape). The overhang portion 15 secures over the top surfaces of the eyewear article, while the attachment clip 16 secures the eyewear against the interior surfaces of the frame. The clip 16 extends along the interior surface of the frame and extends downward from the overhang portion 15 to bear against the eyewear and abut the same against the frame.

Along the backside surface of the frame 11 is a moisture wicking material 20 that is coextensively disposed thereon. This material is a compressible, moisture absorbing and quick drying material that acts as a physical barrier above the user's eyes. The material draws perspiration and moisture from the user's skin through capillary action, and further acts as a blockade against airborne debris or debris within the brow moisture of the wearer. Once moisture is collected in the material 20 and drawn from the user, the material type allows for rapid drying swiftly thereafter. Material contemplated for this task fall into the class of moisture “wicking” materials that have moisture absorbing characteristics and rapid drying qualities. These include polyester fiber materials, microfiber materials, and olefin fiber materials. The material is preferably one that “breathes” and “wicks” moisture from the user. This is generally accomplished through capillary action using materials that do not trap the moisture within its structure, but allow it to flow from the user's skin to the exterior surface of the material. To further the moisture evaporation from the material 20 of the frame, the frame side and front portions may include apertures therethrough to facilitate air flow and evaporative release from the material.

The material of the frame is one of two embodiments: a stiffer material that retains its shape while in use, and a more pliant, less stiff material that can accommodate the eyewear geometry more readily. The stiffer embodiment contemplates a thermoset or thermoplastic material that retains its shape when attached to the eyewear. The pliant embodiment uses a plastic or similar material that is of reduced stiffness, wherein the frame can accommodate changes in its shape when being attached to a particular set of eyewear. The exact material is submitted as being readily understood by one skilled in the art of design and manufacture of eyewear and personal accessory devices.

The present invention is contemplated for use in nearly all types of eyewear, including reading or prescription eyewear, athletic eyewear, and even occupational and activity-specific eyewear (e.g. goggles, etc.). For the embodiment suited for athletic or sport eyewear, the material is for preventing moisture from the environment and moisture from perspiration from entering the eyes of a user. For those wearing reading glasses, the device provides a glare shield and a means to wick sweat from the brow of the wearer, if the wearer happens to experience hyperhidrosis or perspiration through stressful activity. Finally, those that engage in occupations or activities that require eye protection will benefit from the present invention, as the moisture and debris from the environment and from the user's brow is prevented from entering the user's eyes. In any embodiment, the device functions as an eyewear attachment that absorbs and blocks moisture before it enters the eyes, blocks debris from entering behind the eyewear from above the eyes, and provides a glare or shroud from overhead lighting or sunlight.

It can be difficult to prevent perspiration from flowing from one's brow line and entering the ocular regions. Not only can this be uncomfortable and highly inconvenient, it can also momentarily blur people's vision. This requires a user to remove the eyewear and wipe away the sweat that has accumulated, wherein the same procedure will be repeated if the perspiration continues. The present invention describes moisture absorbing eyewear attachment and glare shield. The device comprises a U-shaped frame that attaches to an article of eyewear to prevent perspiration, moisture, debris and sunlight from entering the field of vision of a wearer. The device prevents moisture from impairing vision, and also prevents the eyewear from shifting about on the user's face during activity. This is accomplished by drawing moisture away from the brow line, which protects people's eyes when wearing sport glasses, eyeglasses, protective eyewear, or sunglasses. The device additionally stabilizes eyewear against the wearer's face for a more comfortable fit, while eliminating the hassle of removing a pair of glasses and wiping away sweat.

It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An eyewear attachment device, comprising:
a substantially U-shaped frame comprising a frontal portion and a pair of rearward extending side portions;
said frame comprising an upstanding portion having a lower edge and an upper portion that comprises an outwardly extending overhang portion;
said upstanding portion and said overhang portion forming a substantially inverted J-shape;
said frame comprising a front side surface and a backside surface;
a plurality of eyewear attachment clips disposed along said front side surface of said frame, said eyewear attachment clips adapted to secure over the upper surfaces of an article of eyewear when placed against said frame;
a moisture wicking and quick drying material coextensively disposed along said backside surface.

2) The eyewear attachment device of claim 1, wherein said plurality of eyewear attachment clips further comprises:
at least one side portion attachment clip disposed on said side portions;
and at least one frontal portion attachment clip disposed on said frontal portion;
said at least one side portion attachment clip and said at least one frontal portion attachment clip further comprising substantially U-shaped, elastic members.

3) The eyewear attachment device of claim 1, wherein said plurality of eyewear attachment clips further comprises:
at least one side portion attachment clip disposed on said side portions;
and at least one frontal portion attachment clip disposed on said frontal portion;
said at least one side portion attachment clip further comprising substantially U-shaped, elastic members;
said at least one frontal portion attachment clip further comprising substantially J-shaped, elastic members.

4) The eyewear attachment device of claim 1, wherein said frame further comprises a stiff material that is adapted to retain its shape when attached to an article of eyewear.

5) The eyewear attachment device of claim 1, wherein said frame further comprises an elastic material that is adapted to be readily deformable when attached to an article of eyewear such that said frame can adapt to said eyewear shape.
